(19) United States
(12) Patent Application Publication
(10) Pub. No.: US 2010/0117851 A1
(43) Pub. Date: May 13, 2010

(54) ELECTRONIC APPARATUS WITH INCOMING MESSAGE PROMPT

(75) Inventors: TEH-SHEN LEE, Tu-Cheng (TW); CHIUNG-LI CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/350,236

(22) Filed: Jan. 8, 2009

(30) Foreign Application Priority Data
Nov. 7, 2008 (CN) 200820302687.4

(51) Int. Cl. G08B 7/00

(52) U.S. Cl. 340/815.69

(57) ABSTRACT

An electronic apparatus with incoming message prompt is provided. The electronic apparatus includes an input unit, a receiver, an indicator light, a memory, and a processor. The processor connected with the indicator light and the memory, is configured for controlling the indicator light to flash corresponding colored lights in different rates according to the message ID table and the incoming message.

### TECHNICAL FIELD

The disclosure relates to an electronic apparatus with incoming message prompt.

### DESCRIPTION OF RELATED ART

Electronic apparatuses such as mobile phones play an important role in people's life and are a necessary part of daily life. Those mobile phones can receive news, weather, e-mail, stock quotes, and so on. Generally, when there is an incoming message, a phone is set to play a melody, however, in hospitals, offices, libraries etc., the melody prompt may be unwelcome and intrusive. Of course, the phone can be set to a vibration mode, but the vibration prompt is easy to be missed if you are not near your phone.

An electronic apparatus that uses a light as a prompt seems to resolve the problems described above, for example, when there is an incoming call, a light on the phone can flash, but the light prompt cannot impart other information, such as types, and importance of incoming message, to the user other than alerting the user of an incoming information or message. Therefore, what is needed is an electronic apparatus with an incoming message prompt which can overcome the aforementioned shortcomings.

### BRIEF DESCRIPTION OF THE DRAWINGS

The components of the drawings are not necessarily drawn to scale, the emphasis instead being placed upon clearly illustrating the principles of an electronic apparatus. Moreover, in the drawings, like reference numerals designate corresponding parts throughout several views.

FIG. 1 is a block diagram of an electronic apparatus in accordance with an exemplary embodiment.

FIG. 2 is a schematic view of an electronic book reading apparatus with an indicator light in accordance with an exemplary embodiment.

FIG. 3 is an exemplary schematic diagram illustrating an incoming message ID table with an exemplary embodiment.

### DETAILED DESCRIPTION OF EMBODIMENTS

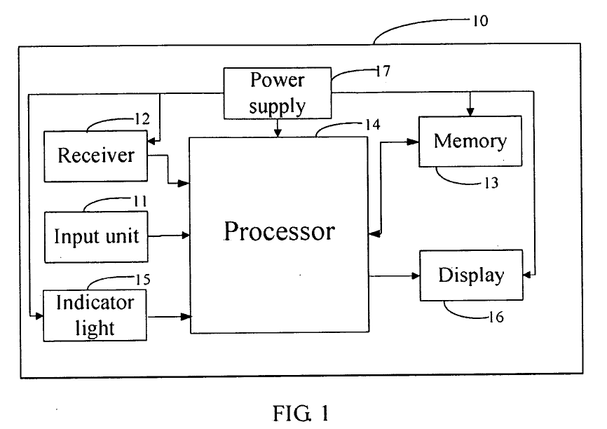

FIG. 1 is a block diagram of a hardware infrastructure of an electronic apparatus 10 in accordance with an exemplary embodiment. The electronic apparatus 10 includes at least one input unit 11, a receiver 12, a memory 13, a processor 14, an indicator light 15, a display 16, and a power supply 17.

The input unit 11 is configured for receiving user input.

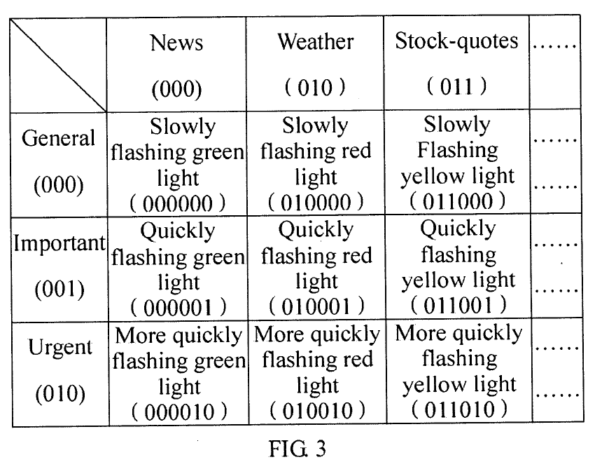

The receiver 12 is configured for receiving incoming message. Each message includes a message ID, wherein the message ID records at least type, and the level of importance of the message, for example, the message may be general, important, or urgent. In the exemplary embodiment, the message ID is coded (for example, in binary code), which can be recognized by the electronic apparatus 10. The coded message ID includes, but is not limited to, type and the level of importance of the message. For easily understanding of the present disclosure, an exemplary binary code embodiment is illustrated hereinafter. For example, the message ID is composed of six bit binary code, the leftmost three bits identifies the message type, and the other three bits identify the level of importance of the message. Referring to FIG. 3, for message type 000 identifies that the message is a news story or headlines, 010 identifies the message is a weather report, and 011 identifies the message is stock quotes. For a level of importance of a message 000 means general message, 001 means important, and 010 means urgent message. Therefore, when the electronic apparatus 10 receives an urgent weather message for example, the code of the message ID is 010010.

The memory 13 is configured for storing a message ID table (see FIG. 3), wherein the message ID table can be defined by a user manually. The message ID table includes, in this embodiment, a row for types of incoming message and a column for importance of the incoming message, an orthogonal array of rows and columns for associating various message IDs with specific color and behavior of a light. For example, as shown in FIG. 3, an incoming important weather message associated with emitting a quickly flashing red light.

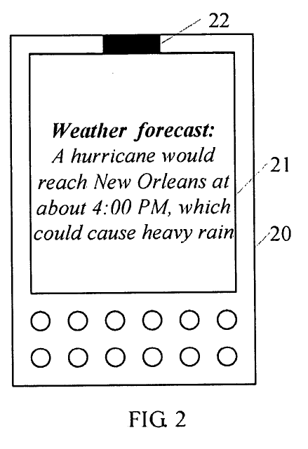

The indicator light 15 is configured for flashing light at different rates and in different colors. The indicator light 15 is installed in a visible place in the electronic apparatus. For example, in the exemplary embodiment as shown in FIG. 2, an indicator light 22 is installed in the front of the electronic book reading apparatus 21. The display 16 is configured for displaying incoming message.

The power supply 17 is configured for supplying electrical power to all elements of the electronic apparatus.

The processor 14 is connected to the input unit 11, the receiver 12, the memory 13, the indicator light 15, the display 16, and the power supply 17. The processor 14 is configured for controlling the indicator light 15 to flash light at different rates and in different colors according to the message ID table while there is an incoming message. In the exemplary embodiment, when the incoming message is important news, the processor 14 controls the indicator light 15 to quickly flash green light as a prompt according to the message ID table in FIG. 3.

In the exemplary embodiment as shown in FIG. 2, the electronic book reading apparatus 20 is taken as the electronic apparatus 10, and when there is an incoming message, the processor 14 controls the indicator light 22 to flash corresponding colored light with a pre-set pattern according to the message ID table. For example, when the electronic book reading apparatus 20 receives an urgent weather message, forecasting a hurricane will reach New Orleans at about 4:00 PM and could cause heavy rain, the processor 14 controls the indicator light 22 to flash green light more quickly.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic apparatus with incoming message prompt, comprising:
a power supply;
a receiver for receiving an incoming message;
an input unit for receiving user input;
an indicator light for flashing light at different rates and in different colors;
a memory for storing a message ID table, wherein the table associates message ID with different colors and different rates that the indicator light flashes light; and
a processor connected with the indicator light, the input unit, the receiver, the memory, and the power supply, configured for controlling the indicator light to flash corresponding colored lights at different rates according to the message ID table and the incoming message.

2. The electronic apparatus as described in claim 1, wherein the message ID table is defined by a user manually.

3. The electronic apparatus as described in claim 1, wherein the message ID comprises message type and the level of importance of the incoming message.

4. The electronic apparatus as described in claim 3, wherein the message ID is represented by a binary number with a plurality of bits, at least one bit of the number represents the message ID and at least one bit of the number represents the level of importance.

5. The electronic apparatus as described in claim 4, wherein the binary number is a six bits number, three bits represent the message ID and the other three bits represent the level of importance.

6. The electronic apparatus as described in claim 1, further comprising a display for displaying incoming message.
